(19) United States
(12) Patent Application Publication
(10) Pub. No.: US 2009/0168673 A1
(43) Pub. Date: Jul. 2, 2009

(54) METHOD AND APPARATUS FOR DETECTING AND SUPPRESSING ECHO IN PACKET NETWORKS

(76) Inventors: Lampros Kalampoukas, Brick, NJ (US); Semyon Sosin, Piscataway, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 11/967,338

(22) Filed: Dec. 31, 2007

(51) Int. Cl. H04B 3/20

(52) U.S. Cl. 370/286

(57) ABSTRACT

The invention includes a method and apparatus for detecting and suppressing echo in a packet network. A method according to one embodiment includes extracting voice coding parameters from packets of a reference packet stream, extracting voice coding parameters from packets of a target packet stream, determining whether voice content of the target packet stream is similar to voice content of the reference packet stream by processing the voice coding parameters of the reference packet stream and the voice coding parameters of the target packet stream, and determining whether the target packet stream includes an echo of the reference packet stream based on the determination as to whether the voice content of the target packet stream is similar to voice content of the reference packet stream.

### FIELD OF THE INVENTION

The invention relates to the field of communication networks and, more specifically, to echo detection and suppression.

### BACKGROUND OF THE INVENTION

As packet-based voice technologies have matured, service providers have started implementing packet-based voice implementations in order to reduce operational expenses. During a voice call, a party to the call may hear his own voice due to echoes at the far end of the voice call. The likelihood of such echoes increases when parties to the voice call use hands-free communications capabilities, such as speakerphones. The most common approach for eliminating such echoes is acoustic echo cancellation (AEC). While acoustic echo cancellation in Time Division Multiplexing (TDM) networks is well developed; disadvantageously, there is currently no recognized way of performing acoustic echo cancellation in packet networks, such as Voice over Internet Protocol (VoIP) networks. Furthermore, the problem of acoustic echo has been exacerbated by packet networks because network packet delays can vary widely from packet to packet, as well as by the fact that typical packet propagation latency in packet networks has increased significantly compared to TDM networks.

### SUMMARY OF THE INVENTION

Various deficiencies in the prior art are addressed through the invention of a method and apparatus for detecting and suppressing echo in a packet network. A method according to one embodiment includes extracting voice coding parameters from packets of a reference packet stream, extracting voice coding parameters from packets of a target packet stream, determining whether voice content of the target packet stream is similar to voice content of the reference packet stream using the voice coding parameters of the reference packet stream and the voice coding parameters of the target packet stream, and determining whether the target packet stream includes an echo of the reference packet stream based on the determination as to whether the voice content of the target packet stream is similar to voice content of the reference packet stream.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network in which echo detection and suppression functions of the present invention are implemented within the communication network;

FIG. 2 depicts a representation of the voice call of FIG. 1 for providing echo detection and suppression for one direction of transmission of the voice call of FIG. 1;

FIG. 3 depicts a method of detecting and suppressing echo according to one embodiment of the present invention;

FIG. 4 depicts a method of determining similarity between target voice content and reference voice content according to one embodiment of the present invention;

FIG. 5 depicts a method of determining similarity between target voice content and reference voice content according to one embodiment of the present invention;

FIG. 6 depicts a high-level block diagram showing relationships between voice packets of a target packet stream and voice packets of a reference packet stream;

FIG. 7 depicts rate pattern matching examples for describing rate pattern matching processing;

FIG. 8 depicts a high-level block diagram of a communication network in which echo detection and suppression functions of the present invention are implemented within the end user terminals;

FIG. 9 depicts a high-level block diagram of a communication network in which echo detection and suppression functions of the present invention are implemented within the end user terminals; and

FIG. 10 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention provides echo detection and echo suppression in packet networks where voice content is conveyed between end user terminals using vocoder packets. A vocoder, which typically includes an encoder and a decoder, uses voice coding parameters extracted from voice-carry packets to convey voice content over packet networks. The encoder segments incoming voice information into voice segments, analyzes the voice segments to determine voice coding parameters, quantizes the voice coding parameters into bit representations, packs the bit representations into encoded voice packets, formats the packets into transmission frames, and transmits the transmission frames over a packet network. The decoder receives transmission frames over a packet network, extracts the packets from the transmission frames, unpacks the bit representations, unquantizes the bit representations to recover the voice coding parameters, and resynthesizes the voice segments from the voice coding parameters.

Using the present invention, voice coding parameters of voice content included in encoded voice packets of a reference packet stream are extracted from the encoded voice packets of the reference packet stream, voice coding parameters of voice content included in encoded voice packets of a target packet stream are extracted from encoded voice packets of the target packet stream, the extracted voice coding parameters are processed to identify similarity between voice content of the reference packet stream and voice content of the target packet stream, and a determination as to whether or not echo is detected is performed based on identification of similarity between voice content of the target packet stream and voice content of the reference packet stream. Using the present invention, the echo path delay associated with the target packet stream (indicative of an offset in time between the reference packet stream and the target packet stream) may be automatically determined as a byproduct of the echo detection process.

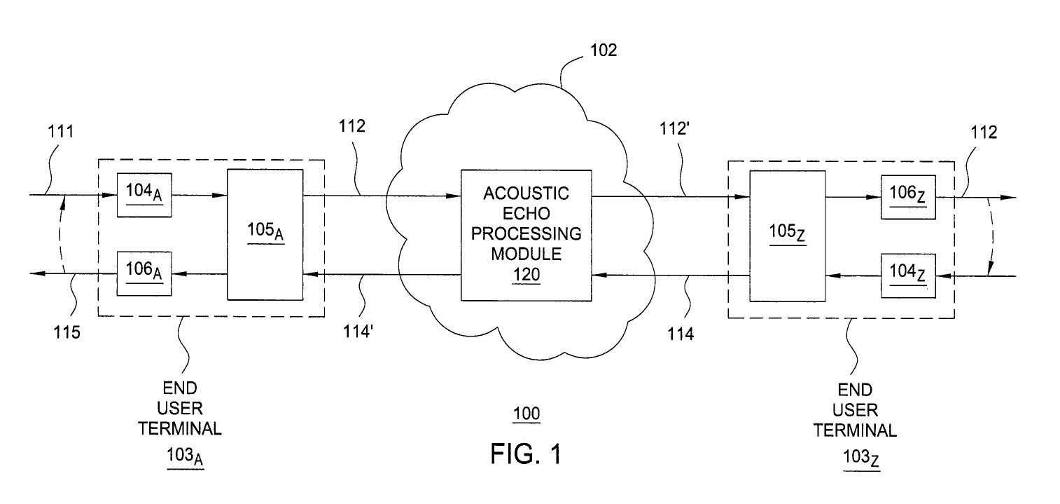

FIG. 1 depicts a high-level block diagram of a communication network. Specifically, communication network 100 of FIG. 1 includes a packet network 102 facilitating communications between an end user A using an end user terminal 103_{A} and an end user Z using an end user terminal 103_{Z} (collectively, end user terminals 103). Specifically, packet network 102 supports a voice call between end user A and end user Z. The packet network 102 conveys voice content (from end user A to end user Z, and from end user Z to end user A) by encoding voice content as encoded voice packets and transmitting the encoded voice packets over packet network 102. As depicted in FIG. 1 the voice call traverses an acoustic echo processing module (AEPM) 120 adapted to detect and suppress/cancel acoustic echo in the voice call.

As depicted in FIG. 1, an end user terminal 103 includes components for supporting voice communications over packet networks, such as audio input/output devices (e.g., a microphone, speakers, and the like), a packet network interface (e.g., including transmitter/receiver capabilities, vocoder capabilities, and the like), and the like. Specifically, end user terminal 103_{A} includes an audio input device 104_{A}, a network interface 105_{A}, and an audio output device 106_{A}, and end user terminal 103_{Z} includes an audio input device 104_{Z}, a network interface 105_{Z}, and an audio output device 106_{Z}. The components of end user terminals 103 may be individual physical devices or may be combined in one or more physical devices. For example, end user terminals 103 may include computers with voice capabilities, VoIP phones, and the like, as well as various combinations thereof.

In voice calls, such as the voice call depicted in FIG. 1, a voice input device of an end user device may pick up both: (1) speech of the local end user and (2) speech received from the remote end user and played over the voice output device of the local end user. For example, where a local end user is using a speakerphone, the microphone of that local end user device may pick up both the speech of the local end user, as well as speech of the remote end user that emanates from the speakerphone. The speech of the remote end user that is received by the voice input device of the local end user may be direct coupling of speech from the speakerphone to the microphone and/or indirect coupling of speech from the speakerphone to the microphone as the speech of the remote end user echoes at the location of the local end user.

With respect to FIG. 1, voice content propagated from end user A to end user Z echoes at the location of end user Z, and the echoing voice content from end user A is picked up by the end user terminal of end user Z, such that the voice content propagated from end user Z to end user A may be a combination of speech of end user Z and echoes of the speech of end user A. Similarly, voice content propagated from end user Z to end user A echoes at the location of end user A, and the echoing voice content from end user Z is picked up by the end user terminal of end user A, such that the voice content propagated from end user A to end user Z may be a combination of speech of end user A and echoes of the speech of end user Z. In other words, echo may be introduced in both directions of a bidirectional communication channel.

For echo introduced at end user device 103_{A}, end user device 103_{A} picks up speech of end user A and, optionally, speech of end user Z played by voice output device 106_{A} (denoted as echo coupling). The speech is picked up by voice input device 104_{A} and provided to network interface 105_{A}, which processes the speech to determine voice coding parameters and packetizes the determined voice coding parameters to form a voice packet stream 112. The end user device 103_{A} propagates voice packet stream 112 to AEPM 120. The AEPM 120 processes the voice packet stream 112 to detect and suppress any speech of end user Z, thereby preventing end user Z from hearing any echo. The AEPM 120 propagates a voice packet stream 112′ (which may or may not be a modified version of voice packet stream 112, depending on whether echo was detected) to end user device 103_{Z}. The voice packet stream 112′ is received by network interface 105_{Z}, which depacketizes and processes the encoded voice parameters to recover the speech of end user A and provides the recovered speech of end user A to voice output device 106_{Z}, which plays the speech of end user A for end user Z.

For echo introduced in at end user device 103_{Z}, end user device 103_{Z} picks up speech of end user Z and, possibly, speech of end user A played by voice output device 106_{Z} (denoted as echo coupling). The speech is picked up by voice input device 104_{Z} and provided to network interface 105_{Z}, which processes the speech to determine voice coding parameters and packetizes the determined voice coding parameters to form a voice packet stream 114. The end user device 103_{Z} propagates voice packet stream 114 to AEPM 120. The AEPM 120 processes the voice packet stream 114 to detect and suppress any speech of end user Z, thereby preventing end user A from hearing any echo. The AEPM 120 propagates a voice packet stream 114′ (which may or may not be a modified version of voice packet stream 114, depending on whether echo was detected) to end user device 103_{A}. The voice packet stream 114′ is received by network interface 105_{A}, which depacketizes and processes the encoded voice parameters to recover the speech of end user Z and provides the recovered speech of end user Z to voice output device 106_{A}, which plays the speech of end user Z for end user A.

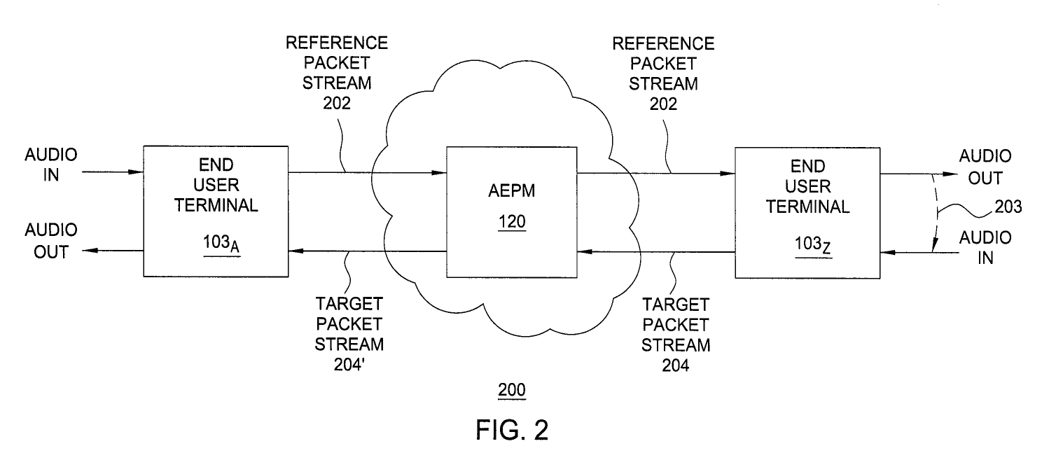

Thus, as depicted in FIG. 1, both directions of voice call traverse AEPM 120 deployed within packet network 102. The AEPM 120 is adapted to detect echo in the voice content propagated between end user A and end user Z and, where echo is detected, suppress or cancel the detected echo such that the end user receiving the voice content does not hear the echo. The AEPM 120 detects echo by extracting voice coding parameters from encoded voice packets of a reference packet stream and encoded voice packets of a target packet stream, and processing the extracted voice coding parameters in a manner for determining whether voice content conveyed by the target packet stream and voice content conveyed by the reference packet stream is similar. The operation of AEPM 120 in extracting voice coding parameters from encoded voice packets conveyed by a target packet stream and a reference packet stream, and using the extracted voice coding parameters to detect and suppress echo, may be better understood with respect to FIG. 2-FIG. 6.

FIG. 2 depicts a representation of the voice call of FIG. 1 for providing echo detection and suppression for one direction of transmission of the voice call of FIG. 1 (for detecting and suppressing echo introduced at end user terminal 103_{Z}). The end user terminal 103_{A} propagates a stream of encoded voice packets (denoted as reference packet stream 202) to AEPM 120. The AEPM 120 maintains a buffer of recently received encoded voice packets of reference packet stream 202 and continues propagating the voice packets of reference packet stream 202 to end user terminal 103_{Z}. The end user terminal 103_{Z} propagates a stream of voice packets (denoted as target packet stream 204) to AEPM 120. The AEPM 120 maintains a buffer of recently received encoded voice packets of target packet stream 204. The AEPM 120 processes the buffered target packets and buffered reference packets to determine whether voice content conveyed by voice packets of target packet stream 204 includes an echo of voice content conveyed by voice packets of reference packet stream 202.

The AEPM 120 provides target packet stream 204′ to end user terminal 103_{A}. If the voice content propagated by encoded voice packets of target packet stream 204 is not determined to include echo of voice content conveyed by encoded voice packets of reference packet stream 202, AEPM 120 continues propagating encoded voice packets of target packet stream 204 to end user terminal 103_{A} (i.e., without adapting the encoded voice packets of target packet stream 204 in a manner for suppressing echo). If the voice content conveyed by encoded voice packets of target packet stream 204 is determined to include an echo of voice content conveyed by encoded voice packets of reference packet stream 202, AEPM 120 adapts encoded voice packets of target packet stream 204 that include the echo of voice content conveyed by encoded voice packets of reference packet stream 202 in a manner for suppressing the echo, and propagates the encoded voice packets of adapted target packet stream 204′ to end user terminal 103_{A}.

As described herein, FIG. 2 depicts a representation of the voice call of FIG. 1 for providing echo detection and suppression for only one direction of transmission; namely, for echo introduced at end user terminal 103_{Z} that is propagated toward end user terminal 103_{A}. Thus, for echo detection and suppression for the other direction of transmission (i.e., for echo introduced at end user terminal 103_{A} that is propagated toward end user terminal 103_{Z}), reference packet stream 202 would be used as the target packet stream and target packet stream 204 would be used as the reference packet stream. Therefore, since echo may be introduced in both directions of transmission of a voice call, for purposes of describing the echo detection and suppression functions of the present invention any components of echo that may be present in reference packet stream 202 are ignored.

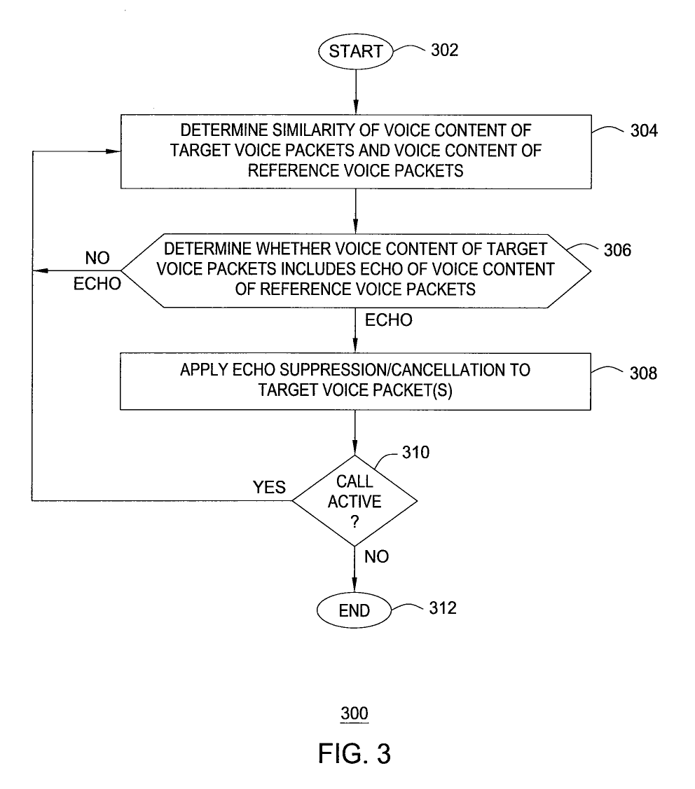

FIG. 3 depicts a method according to one embodiment of the present invention. Specifically, method 300 of FIG. 3 includes a method for detecting echo of voice content of a reference packet stream in voice content of a target packet stream and, if detected, suppressing the echo from the voice content of the target packet stream. Although depicted and described as being performed serially, at least a portion of the steps of method 300 of FIG. 3 may be performed contemporaneously, or in a different order than depicted and described with respect to FIG. 3. The method 300 begins at step 302 and proceeds to step 304.

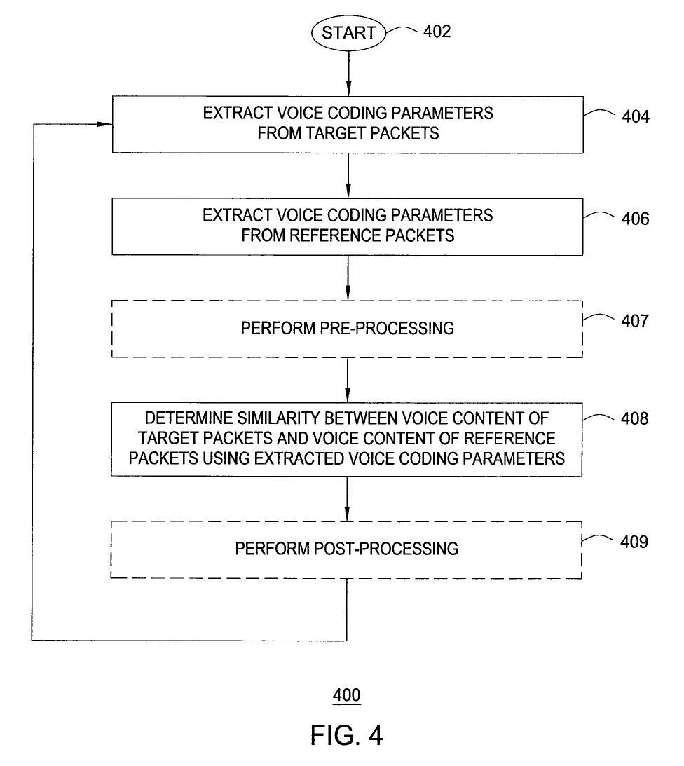

At step 304, similarity between voice content of a target voice packets and voice content of reference voice packets is determined. The similarity between voice content of target voice packets and voice content of reference voice packets is determined by extracting voice coding parameters from the target voice packets, extracting voice coding parameters from the reference voice packets, and processing the extracted voice coding parameters to determine whether the voice content of the target voice packets is similar to the voice content of the reference voice packets. A method for determining similarity between voice content of target voice packets and voice content of reference voice packets using voice coding parameters extracted from the target voice packets and reference voice packets is depicted and described with respect to FIG. 4.

At step 306, a determination is made as to whether the voice content of the target voice packets includes an echo of voice content of the reference voice packets. The determination as to whether the voice content of the target voice packets includes an echo of voice content of the reference voice packets is made using the determination as to whether the voice content of the target voice packets is similar to the voice content of the reference voice packets. If the voice content of the target voice packets does not include an echo of voice content of the reference voice packets, method 300 returns to step 304 (i.e., the current target voice packet(s) is not adapted). If the voice content of the target voice packets does include an echo of voice content of the reference voice packets, method 300 proceeds to step 308.

At step 308, echo suppression is applied to target voice packet(s). The voice content of target voice packet(s) is adapted to suppress or cancel the detected echo. The voice content of target voice packet(s) may be adapted in any manner for suppressing or canceling detected echo. In one embodiment, the voice content of the target packet(s) may be adapted by attenuating the gain of the voice content of the target voice packet(s). In one embodiment, the target voice packet(s) may be replaced with a replacement packet(s). A replacement packet may be a noise packet (e.g., a packet including some type of noise, such as white noise, comfort noise, and the like), a silence packet (e.g., an empty packet), and the like, as well as various combinations thereof.

As depicted in FIG. 3, from step 308, method 300 proceeds to step 310. At step 310, a determination is made as to whether the voice call is active. If the voice call is still active, method 300 returns to step 304 (i.e., echo detection and suppression processing continues in order to detect and remove echo from the voice content of the call). If the voice call is not active, method 300 proceeds to step 312 where method 300 ends. Thus, method 300 continues to be repeated for the duration of the voice call. Although depicted as being performed after echo suppression is applied, method 300 may end at any point in method 300 in response to a determination that the voice call is no longer active.

FIG. 4 depicts a method according to one embodiment of the present invention. Specifically, method 400 of FIG. 4 includes a method for determining similarity between voice content of target voice packets and voice content of reference voice packets. Although depicted and described as being performed serially, at least a portion of the steps of method 400 of FIG. 4 may be performed contemporaneously, or in a different order than depicted and described with respect to FIG. 4. The method 400 begins at step 402 and proceeds to step 404.

At step 404, voice coding parameters are extracted from target voice packets. In one embodiment, voice coding parameters are extracted from each of the N most recent target voice packets (i.e., N is the size of a target window associated with the target packet stream). At step 406, voice coding parameters are extracted from reference voice packets. In one embodiment, voice coding parameters are extracted from each of the K+N most recent reference voice packets. The voice coding parameters may be extracted from voice packets in any manner for extracting voice coding parameters from voice packets. The voice coding parameters extracted from target voice packets and reference voice packets may include any voice coding parameters, such as frequency parameters, volume parameters, and the like.

As described herein, voice coding parameters extracted from voice packets may vary based on many factors, such as the type of codec used to encode/decode voice content, the transmission technology used to convey the voice content, and like factors, as well as various combinations thereof. For example, the voice coding parameters extracted from voice packets may be different for different types of coding to which the present invention may be applied, such as Code Excited Linear Prediction (CELP) coding, Prototype-Pitch Prediction (PPP) coding, Noise-Excited-Linear Prediction (NELP) coding, and the like.

For example, for CELP-based coding, voice coding parameters may include one or more of Line Spectral Pairs (LSPs), Fixed Codebook Gains (FCGs), Adaptive Codebook Gains (ACGs), encoding rates, and the like, as well as various combinations thereof. For example, for PPP-based coding, voice coding parameters may include LSPs, amplitude parameters, and the like. For example, for NELP-based coding, voice coding parameters may include LSPs, energy VQ, and the like. Furthermore, other voice coding parameters may be used (e.g., pitch delay, fixed codebook shape (e.g., the fixed codebook itself), and the like, as well as various combinations thereof).

For example, one form of CELP-based coding is Enhanced Variable Rate Coding (EVRC), which is a specific implementation of a CELP-based coder used in Code Division Multiple Access (CDMA) networks. For example, EVRC-B, an enhanced version of EVRC that includes CELP-based and non-CELP based voice coding parameters, is used in CDMA networks and other networks. In EVRC-B voice coding, additional voice coding parameters for different compress types (e.g., PPP or NELP) may be used (i.e. in addition to typical CELP-based voice coding parameters), such as Amplitude, Global Alignment, and Band Alignment for PPP frames. For example, Global System for Mobile (GSM) networks use Adaptive Multirate (AMR) compression, which uses algebraic CELP (ACELP). Additionally, for example, TeleType (TTY) terminal data may be extracted from encoded voice packets.

At step 407 (an optional step), preprocessing may be performed. In one embodiment, preprocessing may be performed on some or all of the extracted voice coding parameters. For example, raw voice coding parameters extracted from target voice packets and reference voice packets may be processed to smooth the extracted voice coding parameters for use in determining whether there is similarity between the voice content of the target voice packets and voice content of the reference voice packets. In one embodiment, preprocessing may be performed on some or all of the target voice packets and/or reference voice packets based on the associated voice coding parameters extracted from the respective target voice packets and reference voice packets.

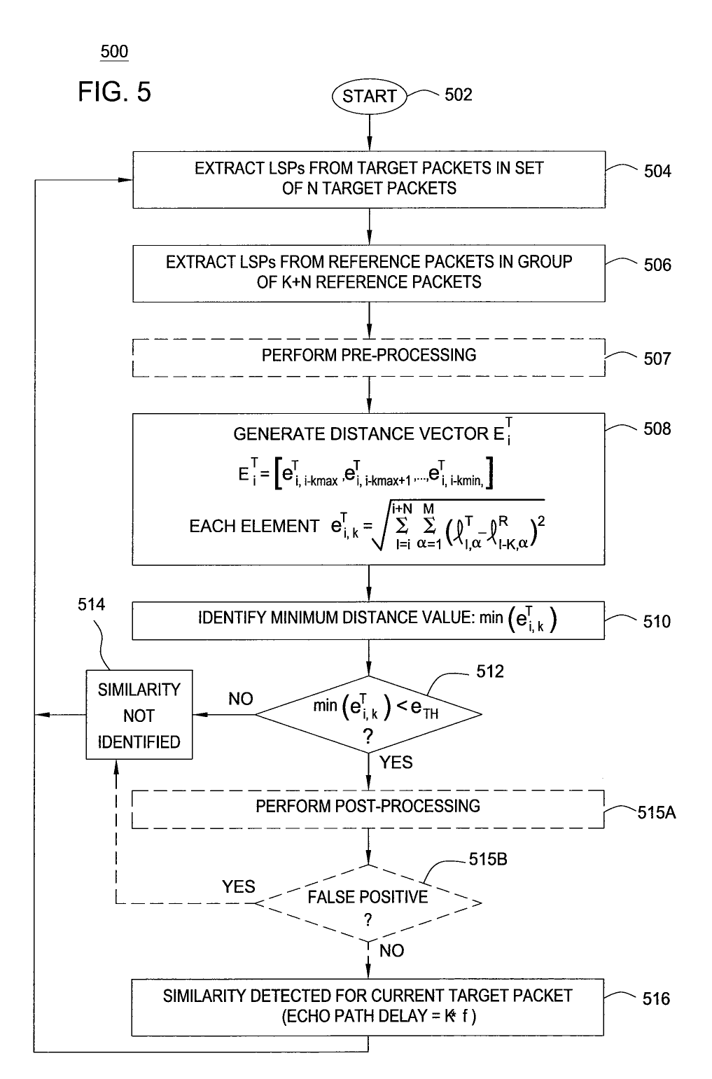

In one embodiment, one or more thresholds utilized in determining whether there is similarity between voice content of the target packets and voice content of the reference packets may be dynamically adjusted based on pre-processing of some or all of the voice coding parameters extracted from the respective voice packets. In one embodiment, for example, an average volume per target window may be determined (i.e., using volume information extracted from each of the target packets of the target window) and used in order to adjust one or more thresholds. In one such embodiment, an average volume per target window may be used to dynamically adjust a threshold used in order to determine whether there is similarity between voice content of the target packets and voice content of the reference packets (e.g., dynamically adjusting an LSP similarity threshold as depicted and described with respect to FIG. 5).

At step 408, similarity between voice content of the target voice packets and voice content of the reference voice packets is determined using the voice coding parameters extracted from the target voice packets and the voice coding parameters extracted from the reference voice packets. In one embodiment, the similarity determination is a binary determination (e.g., either a similarity is detected or a similarity is not detected). In this embodiment, for example, a similarity indicator may be set (e.g., SIMILARITY=YES or SIMILARITY=NO) for each target packet based on the result of the similarity determination. In one embodiment, the similarity determination may be a determination as to a level of similarity between the voice content of the target voice packets and the voice content of the reference voice packets. In this embodiment, for example, the voice content similarity may be expressed using a range of values (e.g., a range from 0-10 where 0 indicates no similarity and 10 indicates a perfect match between the voice content of the target voice packets and the voice content of the reference voice packets).

In one embodiment, the determination as to whether voice content of the target voice packets is similar to voice content of the reference voice packets may be performed using only frequency information (or at least primarily using frequency information in combination with other voice characterization information which may be used to evaluate the validity of the result determined using frequency information). In one such embodiment, for example, the determination as to whether voice content of the target voice packets is similar to voice content of the reference voice packets may be performed only using LSPs (e.g., for voice packets encoded using CELP-based coding). A method for using LSPs to determine whether voice content of the target voice packets is similar to voice content of the reference voice packets is depicted and described herein with respect to FIG. 5.

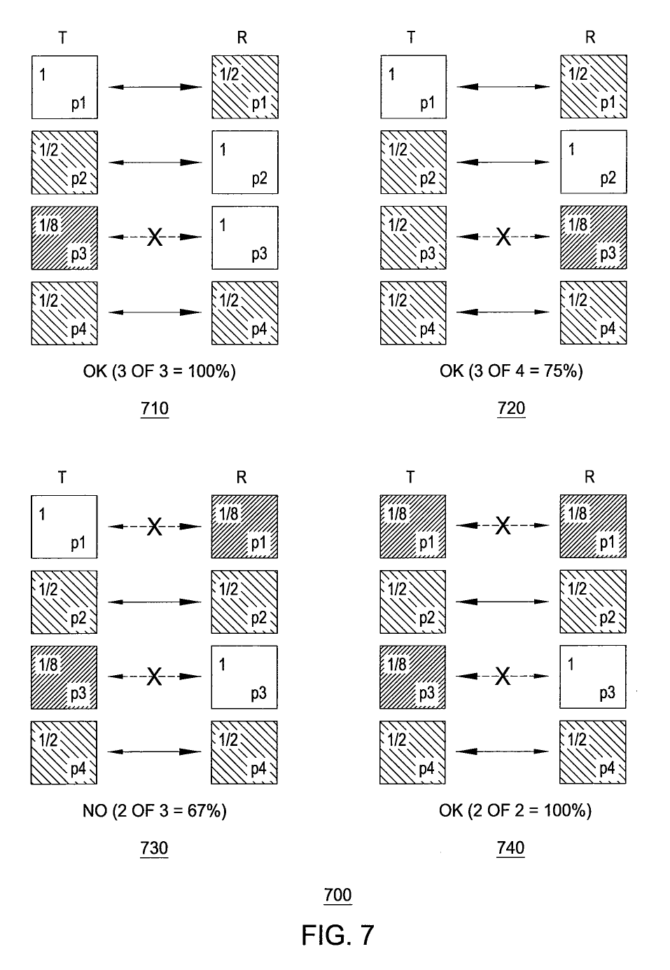

In one embodiment, the determination as to whether voice content of the target voice packets is similar to voice content of the reference voice packets may be performed using rate pattern matching in conjunction with LSP comparisons. In one such embodiment, rate pattern matching may be used to determine the validity of the similarity determination that is made using LSP comparisons. The use of rate pattern matching to determine the validity of the similarity determination may be better understood with respect to FIG. 7.

In one embodiment, the determination as to whether voice content of the target voice packets is similar to voice content of the reference voice packets may be performed using rate/type matching in conjunction with LSP comparisons. In one such embodiment, rate/type matching may be used to determine the validity of the similarity determination that is made using LSP comparisons. In another embodiment, the determination as to whether voice content of the target voice packets is similar to voice content of the reference voice packets may be performed using rate/type matching in place of LSP comparisons.

In one embodiment, some of the processing described as being performed as preprocessing (i.e., described with respect to optional step 407) may be performed during the determination as to whether voice content of the target voice packets is similar to voice content of the reference voice packets. For example, other voice coding parameters extracted from the target packets and/or the reference packets may be used during the determination as to whether voice content of the target voice packets is similar to voice content of the reference voice packets (e.g., to ignore selected ones of the voice packets such that those voice packets are not used in the comparison between target and reference voice packets, to assign weights to selected ones of the voice packets, to dynamically modify one or more thresholds used in performing the similarity determination, and the like, as well as various combinations thereof).

At step 409 (an optional step), post-processing may be performed. In one embodiment, post-processing may be performed on the result of the similarity determination. The post-processing may be performed using some or all of the voice coding parameters extracted from the target voice packets and reference voice packets. In one embodiment, post-processing may include evaluating the result of the similarity determination. In one such embodiment, for example, the result of the similarity determination may be evaluated in a binary manner (e.g., in a manner for declaring the result valid or invalid, i.e., for declaring the result a true positive or a false positive). In one embodiment, for example, the result of the similarity determination may be evaluated in a manner for assigning a weight or importance to the result of the similarity determination. The result of the similarity determination may be evaluated in various other ways.

In some such embodiments, evaluation of the result of the similarity determination may be based on the percentage of the target voice packets that are considered valid/usable and/or the percentage of reference voice packets that are considered valid/usable. In one embodiment, volume characteristics of the voice packets used to perform the similarity determination may be used to determine the validity/usability of the respective voice packets. For example, where a certain percentage of the target voice packets have a volume below a threshold and/or a certain percentage of reference voice packets have a volume below a threshold, a determination may be made that the result of a similarity determination is invalid, or at least less useful than a similarity determination in which a higher percentage of the voice packets are determined to be valid/usable. Although primarily described with respect to volume, various other extracted voice coding parameters may be used to evaluate the results of the similarity determination.

As depicted in FIG. 4, from step 408 (or, optionally, from step 409), method 400 returns to step 404 such that method 400 is repeated (i.e., voice coding parameters are extracted and processed for determining whether there is a similarity between voice content of the target voice packets and the reference voice packets). The method 400 may be repeated as often as necessary. In one embodiment, for example, method 400 may be repeated for each target voice packet. In one such embodiment, the N target voice packets of a target packet stream that are buffered may operate as a sliding window such that, for each target voice packet that is received, the N most recently received target voice packets are compared against K sets of the most recently received K+N reference voice packets in order to determine similarity between voice content of the target voice packets and voice content of the reference voice packets. The method 400 may be repeated less often or more often.

FIG. 5 depicts a method according to one embodiment of the present invention. Specifically, method 500 of FIG. 5 includes a method of determining similarity between voice content of target voice packets and voice content of reference voice packets using frequency information extracted from the target voice packets and reference voice packets. In one embodiment, method 500 may be performed as step 304 of method 300 of FIG. 3. Although depicted and described as being performed serially, at least a portion of the steps of method 500 of FIG. 5 may be performed contemporaneously, in a different order than depicted and described with respect to FIG. 5. The method 500 begins at step 502 and proceeds to step 504.

At step 504, line spectral pair (LSP) values are extracted from target packets in a set of N target packets of the target packet stream. In one embodiment, a set of M LSP values is extracted from each of N target packets in a set of N target packets.

In one embodiment, the set of N target packets are consecutive target packets. In this embodiment, N is the size of the target window associated with the stream of target packets. The value of N may be set to any value. In one embodiment, for example, N may be set in the range of 5-10 target packets (although the value of N may be smaller or larger). In one embodiment, the value of N may be adapted dynamically (e.g., dynamically increased or decreased).

In one embodiment, M LSP values are extracted from each of the N target packets. In one embodiment, the value of M may be set to a value for each target packet. In one embodiment, for example, M may be set to 10 LSP values for each target packet (although fewer or more LSP values may be extracted from each target packet.

In one embodiment, the set of LSP values extracted from the N target packets may be represented as a two-dimensional matrix. The two-dimensional matrix is dimensioned over M and N, where M is the number of LSP values extracted from each target packet and N is the number of consecutive target packets from which LSPs are extracted (i.e., N is the size of the sliding window associated with the stream of target packets). An exemplary two-dimensional matrix defined for the N sets of M LSP values extracted from the N target packets may be represented as:

$${L}_{i}^{T} = [ \begin{matrix}{l}_{i , 1}^{T} & {l}_{i , 2}^{T} & … & {l}_{i , M}^{T} \\ {l}_{i + 1 , 1}^{T} & {l}_{i + 1 , 2}^{T} & … & {l}_{i + 1 , M}^{T} \\ ⋮ & ⋮ & … & ⋮ \\ {l}_{i + N , 1}^{T} & {l}_{i + N , 2}^{T} & … & {l}_{i + N , M}^{T}\end{matrix} ]$$

As depicted in the two-dimensional matrix defined for the sets of LSP values extracted from the N consecutive target packets, l is the LSP value, T designates that the LSP value is extracted from a target packet, the first subscript identifies the target packet from which the LSP value was extracted (in a range from i through i+N), and the second subscript identifies the LSP value extracted from the target packet identified by the first subscript. In other words, LT indicates that the two-dimensional matrix was created for target packet i, and each row of the two-dimensional matrix includes the M LSP values extracted from the target packet identified by the first subscript associated with each of the LSP values of that row of the two-dimensional matrix.

At step 506, line spectral pair (LSP) values are extracted from reference packets in a set of K+N reference packets of the reference packet stream. In one embodiment, a set of M LSP values is extracted from each of K+N reference packets in the group of K+N reference packets.

The group of K+N reference packets is organized as K sets of reference packets where each of the K sets of reference packets includes N reference packets, thereby resulting in K sets of LSP values from K sets of reference packets. This enables pairwise evaluation of the set of N target packets with each of the K sets of N reference packets. In one embodiment, the N reference packets in each of the K sets of reference packets are consecutive reference packets. As described with respect to target packets, the value of N may be set to any value and, in some embodiments, may be adapted dynamically.

In one embodiment, M LSP values are extracted from each of the N reference packets in each of the K sets of reference packets. In one embodiment, the value of M is equal to the value of M associated with target packets, thereby enabling a pairwise evaluation of the LSP values of each of the N target packets with LSP values of each of the N reference packets included in each of the K sets of reference packets. As described with respect to target packets, the value of M may be set to any value and, in some embodiments, may vary across reference packets.

The value of K is a configurable parameter, which may be expressed as a number of reference packets. The value of K is representative of the echo path delay that is required to be supported. The echo path delay (in time units) should have the granularity of the packet sampling interval. For example, for EVRC coding, the packet sampling interval is 20 ms. Thus, in this example, where an acoustic echo cancellation module according to the present invention is required to detect an echo path delay of up to 500 ms (e.g., as in EVRC coding), the value of K should be set at least to 25 voice packets (or more).

In one embodiment, the K*N sets of LSP values extracted from the K sets of reference packets may be represented as one three-dimensional matrix (M×N×K) or K two-dimensional matrices (each M×N for the specific value of k), where N is the size of the target window (and, thus, the reference window), K is the number of sets of reference packets (where K=Kₘₐₓ−Kₘᵢₙ+1), and jε(i−Kₘᵢₙ . . . i−Kₘₐₓ). The values of Kₘᵢₙ and Kₘₐₓ may be set to any values (as long as the values satisfy K=Kₘₐₓ−Kₘᵢₙ+1). For example, where K=25, Kₘᵢₙ and Kₘₐₓ may be set to 0 and 24, respectively. An exemplary two-dimensional matrix defined for each of the K sets of LSP values extracted from the K sets of reference packets may be represented as:

$${L}_{j}^{R} = [ \begin{matrix}{j , 1}_{R}^{} & {j , 2}_{R}^{} & … & {j , M}_{R}^{} \\ {j + 1 , 1}_{R}^{} & {j + 1 , 2}_{R}^{} & … & {j + 1 , M}_{R}^{} \\ ⋮ & ⋮ & … & ⋮ \\ {j + N , 1}_{R}^{} & {j + N , 2}_{R}^{} & … & {j + N , M}_{R}^{}\end{matrix} ]$$

As depicted in each of the K two-dimensional matrices defined for the K sets of LSP values extracted from the K consecutive reference packets, l is the LSP value, R designates that the LSP value is extracted from a reference packet, the first subscript identifies the reference packet from which the LSP value was extracted (in a range from j through j+N), and the second subscript identifies the LSP value extracted from the reference packet identified by the first subscript. In other words, Lᵢ^{R} indicates that the two-dimensional matrix was created for reference packet j, and each row of the two-dimensional matrix includes the M LSP values extracted from the reference packet identified by the first subscript associated with each of the LSP values of that row of the two-dimensional matrix.

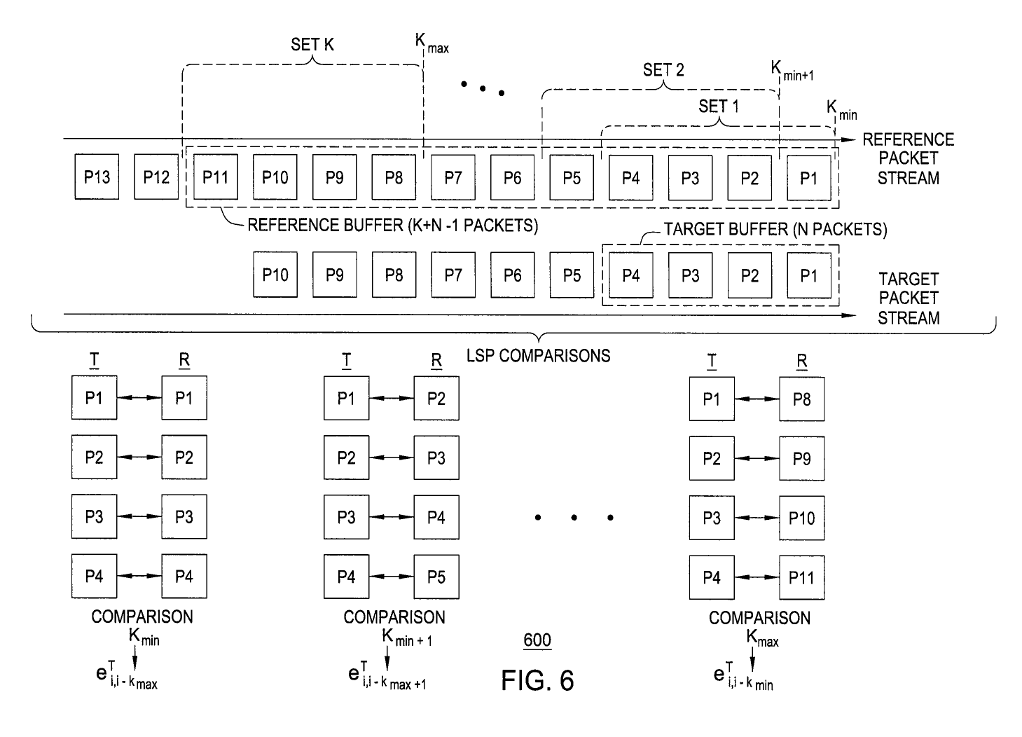

The extraction of LSP values (or other voice coding parameters) from target packets, extraction of LSP values (or other voice coding parameters) reference packets, and evaluation of extracted LSP values (e.g., in a pairwise manner) may be better understood with respect to FIG. 6.

FIG. 6 depicts a high-level block diagram showing relationships between voice packets of a target packet stream and voice packets of a reference packet stream, facilitating explanation of the processing of the target packet stream and reference packet stream. The target packet stream includes target voice packets. The target voice packets are buffered by the AEPM (omitted for purposes of clarity) using a target stream buffer. The target stream buffer stores at least N target packets, where N is the size of the sliding window used for evaluating target packets for detection and suppression of echo from the target packet stream. The reference packet stream includes reference voice packets. The reference voice packets are buffered by the AEPM using a reference stream buffer. The reference stream buffer stores at least K+N reference packets, where K is the number of sets of N reference packets to be compared against the N target packets stored in the target buffer.

As depicted in FIG. 6, the target stream buffer stores four (N) packets (denoted as P1, P2, P3, and P4) and the reference stream buffer stores eleven (K+N) packets (denoted as P1, P2, . . . , P10, P11). In other words, in this example, K is equal to 7 (which may be represented as values 0 through 6). For the current target window, K sets of packet comparisons are performed by sliding the reference window K times (i.e., by one packet each time). Specifically, for the first comparison target packets P1, P2, P3, and P4 are compared with respective reference packets P1, P2, P3, and P4, for the second comparison target packets P1, P2, P3, and P4 are compared with respective reference packets P2, P3, P4, and P5, and so on until the K-th comparison in which target packets P1, P2, P3, and P4 are compared with respective reference packets P8, P9, P10, and P11 (i.e., reference packets P_{K}−P_{K+N}).

As described herein, the comparisons between packets may include comparisons (or other evaluation techniques) of one or more different types of voice coding parameters available from the target packets and reference packets being compared (e.g., using one or more of LSP comparisons, volume comparisons, and the like, as well as various combinations thereof). The evaluation of voice coding parameters of target packets and voice coding parameters of reference packets using such pairwise associations between target packets and reference packets may be better understood with respect to FIG. 5 and, thus, reference is made back to FIG. 5.

At step 507 (an optional step), preprocessing is performed. The pre-processing may include any preprocessing (e.g., such as one or more of the different forms of preprocessing depicted and described with respect to step 407 of method 400 of FIG. 4). For example, selected ones of the target packets and/or reference packets may be ignored (e.g., rate pattern matching is performed such that voice packets considered to be unsuitable for comparison are ignored, such as ⅛ rate voice packets, voice packets having an error, voice packets including teletype information, and other voice packets deemed to be unsuitable for comparison), different weights may be assigned to different ones of the target voice packets and/or reference voice packets, one or more thresholds used in performing the similarity determination may be dynamically adjusted, a weight may be preemptively assigned to the result of the similarity determination, and the like, as well as various combinations thereof.

As described herein, in one embodiment rate pattern matching may be used during the determination as to whether there is similarity between voice content of the target voice packets and voice content of the reference voice packets.

The result of the rate pattern matching processing may be used in a number of ways. In one embodiment, the result of the rate pattern matching processing may be used to reduce the number of LSP comparisons performed during the determination as to whether there is similarity between voice content of the target voice packets and voice content of the reference voice packets (i.e., unsuitable pairs of target packets and voice packets are ignored and are not used in LSP comparisons). In one embodiment, the result of the rate pattern matching processing may be used to determine whether the result of the similarity determination is valid or invalid. The results of the rate pattern matching processing may be used for various other purposes.

In one embodiment, rate pattern matching processing is performed by categorizing packets (target and/or reference packets) with respect to the suitability of the respective packets for use in determining whether there is similarity between voice content of the target voice packets and voice content of the reference voice packets. The packets may be categorized as either comparable (i.e., suitable for use in determining whether there is similarity) or non-comparable (i.e., unsuitable for use in determining whether there is similarity).

The packets may be categorized using various criteria. In one embodiment, the packets may be categorized using voice coding parameters extracted from the packets being categorized, respectively. In one embodiment, for example, the packets may be categorized using packet rate information extracted from the packets. In one such embodiment, for example, full rate packets and half rate packets are categorized as comparable while silence (⅛ rate) packets, error packets, and teletype packets are categorized as non-comparable. As described herein, other criteria may be used for categorizing target and/or reference packets as comparable or non-comparable.

In one embodiment, in which the result of the rate pattern matching processing is used to reduce the number of LSP comparisons performed during the determination as to whether there is similarity between voice content of the target voice packets and voice content of the reference voice packets, only comparable packets will be used for LSP comparisons (i.e., non-comparable packets will be discarded or ignored).

In one embodiment, in which the result of the rate pattern matching processing is used to determine the validity of the result of the similarity determination, rate pattern matching may be performed by determining a number of corresponding target packets and reference packets deemed to be matching, determining a number of target packets deemed to be comparable (versus non-comparable), determining a rate pattern matching value by dividing the number of corresponding target packets and reference packets with matching rates by the number of target packets deemed to be comparable, and comparing the rate pattern matching value to the rate pattern matching threshold. A target packet and reference packet are deemed to match if both the target packet and the reference packet are deemed to be comparable (if either or both of the target packet and reference packets are deemed to be non-comparable, there is no match). This process may be better understood with respect to the examples of FIG. 7.

FIG. 7 depicts rate pattern matching examples for describing rate pattern matching processing. Specifically, four rate pattern matching examples are depicted (labeled as comparison examples 710, 720, 730, and 740). As depicted in FIG. 7, each comparison example includes a comparison of four target packets (denoted by “T” and packet numbers P1, P2, P3, and P4, and including information indicative of the packet rates of the respective packets) and four reference packets (denoted by “R” and packet numbers P1, P2, P3, and P4, and including information indicative of the packet rates of the respective packets).

In comparison example 710 the target packets P1, P2, P3, and P4 have packet rates of 1, ½, ⅛, and ½, respectively, and the reference packets P1, P2, P3, and P4 have packet rates of ½, 1, 1, and ½, respectively. In this example, there are three matches of target packets to reference packets (P1, P2, and P4), and there are three comparable target packets (P3 is non-comparable), so the rate pattern matching value is 3/3=100%. Since the threshold in this example is 75%, the associated similarity determination would be deemed to be valid because the rate pattern matching value satisfies the rate pattern matching threshold.

In comparison example 720 the target packets P1, P2, P3, and P4 have packet rates of 1, ½, ½, and ½, respectively, and the reference packets P1, P2, P3, and P4 have packet rates of ½, 1, ⅛, and ½, respectively. In this example, there are three matches of target packets to reference packets (P1, P2, and P4), and there are four comparable target packets, so the rate pattern matching value is ¾=75%. Since the threshold in this example is 75%, the associated similarity determination would be deemed to be valid because the rate pattern matching value satisfies the rate pattern matching threshold.

In comparison example 730 the target packets P1, P2, P3, and P4 have packet rates of 1, ½, ⅛, and ½, respectively, and the reference packets P1, P2, P3, and P4 have packet rates of ⅛, ½, 1, and ½, respectively. In this example, there are two matches of target packets to reference packets (P2 and P4), and there are three comparable target packets (P3 is non-comparable), so the rate pattern matching value is ⅔=67%. Since the threshold in this example is 75%, the associated similarity determination would be deemed to be invalid because the rate pattern matching value does not satisfy the rate pattern matching threshold.

In comparison example 740 the target packets P1, P2, P3, and P4 have packet rates of ⅛, ½, ⅛, and ½, respectively, and the reference packets P1, P2, P3, and P4 have packet rates of ⅛, ½, 1, and ½, respectively. In this example, there are two matches of target packets to reference packets (P2 and P4), and there are two comparable target packets (P1 and P3 are each non-comparable), so the rate pattern matching value is 2/2=100%. Since the threshold in this example is 75%, the associated similarity determination would be deemed to be valid because the rate pattern matching value satisfies the rate pattern matching threshold.

Although depicted and described with respect to specific ways of determining the rate pattern matching value, the rate pattern matching value may be determined in various other ways. In one embodiment, for example, the rate pattern matching value may be computed using a number of reference packets deemed to be comparable (rather than, as described hereinabove, where the rate pattern matching value is computed using the number of target packets deemed to be comparable). The rate pattern matching value may be computed in other ways.

Although primarily depicted and described with respect to an embodiment in which the rate pattern matching threshold is a specific value (i.e., rate pattern matching threshold=75%), the rate pattern matching threshold may be any value. Furthermore, in some embodiments, the rate pattern matching threshold may be static, while in other embodiments the rate pattern matching threshold may be dynamically updated (e.g., based on one or more of extracted voice coding parameters, pre-processing results, and the like, as well as various combinations thereof).

Although primarily depicted and described with respect to being categorized as comparable packets or non-comparable packets, voice packets may be categorized using different packet categories and/or using more packet categories. Although primarily depicted and described as being categorized based on certain information associated with each of the voice packets, each of the voice packets may be categorized based on various other criteria or combinations of criteria (which may or may not include voice coding parameters extracted from the respective voice packets).

In one embodiment, rate/type matching may be used during the determination as to whether there is similarity between voice content of the target voice packets and voice content of the reference voice packets.

The result of the rate/type matching processing may be used in a number of ways. In one embodiment, the result of the rate/type matching processing may be used to reduce the number of LSP comparisons performed during the determination as to whether there is similarity between voice content of the target voice packets and voice content of the reference voice packets (i.e., unsuitable pairs of target packets and voice packets are ignored). In one embodiment, the result of the rate/type matching processing may be used to determine whether the result of the similarity determination is valid or invalid. The results of the rate/type matching processing may be used for various other purposes.

In one embodiment, rate/type matching is performed by categorizing packets, where each packet is categorized using a combination of the rate of the packet and the type of the packet. The type may be assigned based on one or more characteristics of the packet. In one embodiment, for example, the type of the packet may be assigned based on the type of encoding of the packet. The packet categories of target packets in the target window are compared to the packet categories of corresponding reference packets in the reference window. The different possible combinations of packet comparisons are assigned respective weights. The sum of the weights associated with the packet comparisons between target packets in the target window and reference packets in the reference window is compared to a threshold to determine whether the associated similarity determination is deemed to be valid or invalid.

For example, in EVRC-B there are different packet rates (e.g., full, half, quarter, eighth) and different packet encodings (e.g., CELP, PPP, NELP). Using combinations of packet rates and packet types, there are currently nine packet categories (e.g., full rate, half-rate, and special half-rate CELP; full rate, special half-rate, and quarter-rate PPP; special half-rate and quarter-rate NELP; and silence, which is eight-rate) which can give 81 possible permutations. In this EVRC-B example, each type of packet comparison would be assigned a weight. For example, a comparison of target packet this is full rate CELP to a reference packet that is full rate CELP is assigned a weight, a comparison of a target packet that is quarter-rate NELP to a reference packet that is special half-rate PPP is assigned a weight, and so on. The similarity determination for a target window of target packets and a reference window of reference packets is evaluated by summing the weights of the comparison types identified when the target packets are compared to the reference packets and comparing the sum of weights to a threshold.

Since this EVRC-B example results in at least nine different packet categories, for purposes of clarity in describing the operation of rate/type matching assume that there are three packet categories, denoted as A, B, and C. In this simplified example, there are nine possible combinations of packet comparisons between target packets and reference packets, namely A-A (0), A-B (1), A-C (2), B-A (1), B-B (0), B-C (3), C-A (2), C-B (3), and C-C (0), each of which is assigned an associated weight (listed in parentheses next to the comparison type). In this example, assume that the threshold is 2 such that if the sum of weights is less than or equal to 2 then the similarity determination is valid and if the sum of weights is greater than 2 then the similarity determination is invalid.

In continuation of this example, assume that there is a first comparison of a target window to a reference window. The target window is (B, A, C, A) and the reference window is (A, B, C, A), resulting in packet comparisons of (B-A, A-B, C-C, A-A) having associated weights of (1, 1, 0, 0). In this example, the sum of weights is 2, which is equal to the threshold. Thus, in this example, a determination is made that the similarity determination is valid.

In continuation of this example, assume that there is a second comparison of a target window to a reference window. The target window is (C, B, C, A) and the reference window is (A, B, C, A), resulting in packet comparisons of (C-A, B-B, C-C, A-A) having associated weights of (2, 0, 0, 0). In this example, the sum of weights is 2, which is equal to the threshold. Thus, in this example, a determination is made that the similarity determination is valid.

In continuation of this example, assume that we have a third comparison of a target window to a reference window. The target window is (A, C, C, A) and the reference window is (A, B, C, A), resulting in packet comparisons of (A-A, C-B, C-C, A-A) having associated weights of (0, 3, 0, 0). In this example, the sum of weights is 3, which is greater than the threshold. Thus, in this example, a determination is made that the similarity determination is invalid.

Although primarily described with respect to an example in which weights are symmetrical (e.g., the weight of A-B is 1 and the weight of B-A is 1), in other embodiments non-symmetrical weights may be used (e.g., the weight of A-B could be 1 and the weight of B-A could be 3). Although described with respect to an embodiment in which a sum of weights below the threshold indicates that the similarity determination is valid, in other embodiments the weights may be assigned to the packet comparisons such that a sum of weights above the threshold indicates that the similarity determination is valid. Although described with request to specific values of the weights and the threshold, various other values of the weights and/or threshold (including static thresholds and/or dynamic thresholds) may be used.

Although primarily described with respect to using rate/type matching in combination with LSP comparisons for determining whether there is a similarity between voice content of target packets and voice content of reference packets (e.g., for determining whether a similarity determination made using LSP comparisons is valid or invalid), in one embodiment rate/type matching may also be used in place of LSP comparisons for determining whether or not there is a similarity between voice content of target packets and voice content of reference packets. In this embodiment, comparison of the sum of weights with the threshold is used to determine whether or not there is a similarity between voice content of target packets and voice content of reference packets (rather than, as described hereinabove, for determining the validity of a similarity determination made using LSP comparisons).

At step 508, a distance vector (denoted as Eᵢ^{T}) is generated. The distance vector Eᵢ^{T} includes K distance values computed as distances between LSP values extracted from the N target packets and each of the K sets of LSP values extracted from the K sets of N reference packets received during the window of i−Kₘᵢₙ . . . i−Kₘₐₓ. More specifically, distance vector Eᵢ^{T}, which corresponds to the window of N target packets starting with target packet i, is defined as a vector of K distance values (where K=Kₘₐₓ−Kₘᵢₙ+1) as follows: Eᵢ^{T}=[e_{i,i-K}_{ₘₐₓ}^{T}, e_{i,i-K}_{ₘₐₓ}₊₁^{T}, . . . , e_{i,i-K}_{ₘᵢₙ}^{T}], where each distance value e_{i,k}^{T} (with Kₘᵢₙ≦k≦Kₘₐₓ) is defined as follows:

$${e}_{i , k}^{T} = \sqrt{{\sum }_{I = i}^{i + N} {\sum }_{α = 1}^{M} {( {l}_{I , α}^{T} - {l}_{I - k , α}^{R} )}^{2}}$$

At step 510, the minimum distance value e_{i,k}^{T} of distance vector Eᵢ^{T} is identified (as min[e_{i,k}^{T}] for e_{i,k}^{T}εEᵢ^{T}, ∀Kₘᵢₙ≦k≦Kₘₐₓ). At step 512, the minimum distance value min[e_{i,k}^{T}] is compared to a threshold (denoted as an LSP similarity threshold eₜₕ) in order to determine whether the minimum distance value min[e_{i,k}^{T}] satisfies LSP similarity threshold eₜₕ). The comparison may be performed as: min [e_{i,k}^{T}]<eₜₕ, or min [e_{i,k}^{T}]>eₜₕ.

In one embodiment, LSP similarity threshold eₜₕ is a predefined threshold. In one embodiment, LSP similarity threshold eₜₕ is dynamically adaptable. In one embodiment, LSP similarity threshold eₜₕ may be dynamically adapted based on extracted voice coding parameters. In one such embodiment, for example, the LSP similarity threshold eₜₕ may be dynamically adapted processing of extracted voice coding parameters (e.g., where the extracted voice coding parameters may be processed during pre-processing, during LSP similarity determination processing, and the like, as well as various combinations thereof).

In one embodiment, for example, LSP similarity threshold eₜₕ may be dynamically adapted based on volume information extracted from the target packets and/or reference packets. In one such embodiment, for example, when the volume of voice content in the target packet(s) is low (e.g., below a threshold), LSP similarity threshold eₜₕ may be increased (because if the volume of voice content in the target packet(s) is low, it is possible that the encoded voice is distorted due to quantization/encoding effects). Although primarily described with respect to adapting LSP similarity threshold eₜₕ based on volume of the voice content, LSP similarity threshold eₜₕ may be adapted (i.e., increased or decreased) based on various other parameters.

As described herein, the minimum distance value e_{i,k}^{T} of distance vector Eᵢ^{T} is compared to LSP similarity threshold eₜₕ in order to determine whether a similarity is detected for the current target packet (i.e., target packet i). If min [e_{i,k}^{T}]>eₜₕ, a similarity is not detected for the current target packet (depicted as step 514), and from step 514, method 500 returns to step 504 to re-execute method 500 for the next current target packet, i.e., i=i+1). If min[e_{i,k}^{T}]<eₜₕ, a similarity is detected for the current target packet (depicted as step 516), and from step 516, method 500 returns to step 504 to re-execute method 500 for the next current target packet, i.e., i=i+1).

Although primarily depicted and described with respect to maintaining matrices of LSP values extracted from target packets and sets of reference packets, the extracted LSP values may be maintained in any manner enabling evaluation of the extracted LSP values. Although primarily depicted and described with respect to generating a distance vector Eᵢ^{T} including K distance values, the K distance values associated with K sets of LSP values, respectively, may be computed without maintaining the K distance values in a vector (e.g., the K distance values may be simply be stored in memory for processing the K distance values to determine whether a similarity is identified).

Although primarily depicted and described herein with respect to an embodiment in which the minimum distance value (i.e., only one of the distance values) is compared against the LSP similarity threshold in order to determine whether a similarity is identified, in other embodiments multiple distance values may be compared against the LSP similarity threshold in order to determine whether a similarity is identified. In one such embodiment, for example, a certain number of the distance values must be below the LSP similarity threshold in order for a similarity to be identified (i.e., a threshold number of the distance values must be below the LSP similarity threshold in order for a similarity to be identified).

Although primarily depicted and described herein with respect to an embodiment in which all distance values of the distance vector are computed before a comparison with the LSP similarity threshold is performed, in one embodiment, each distance value of the distance vector may be compared against the LSP similarity threshold as the distance value is computed.

In one such embodiment, where only one distance value is required to be below the LSP similarity threshold in order for a similarity to be identified, a similarity may be identified in response to a determination that one of the distance values is less than the LSP similarity threshold (i.e., rather than computing the remaining distance values of the distance vector). For example, where K=25, upon detection of the 1^{st} distance value that is below the LSP similarity threshold (which may be determined after anywhere from 1 through 25 distance values are calculated), a similarity is deemed to have been identified.

In another such embodiment, where multiple distance values are required to be below the LSP similarity threshold in order for a similarity to be identified (e.g., a threshold number of the distance values must be below the LSP similarity threshold, a similarity may be identified in response to a determination that a threshold number of the distance values are less than the LSP similarity threshold (i.e., rather than computing the remaining distance values of the distance vector). For example, where K=25 and at least 10 of the 25 distance values must be below the LSP similarity threshold in order for similarity to be identified, upon detection of the 10^{th} distance value that is below the LSP similarity threshold (which may be determined after anywhere from 10 through 25 distance values are calculated), a similarity is deemed to have been identified.

Although primarily depicted and described with respect to an embodiment in which the distance values are computed using the extracted LSP values, in other embodiments the distance values may be computed using weighted LSP values.

In one embodiment, for example, each of the M LSP values extracted from each target packet and each reference packet may be assigned a weight and the LSP values may be adjusted according to the assigned weight prior to computing the distance values.

In another embodiment, for example, for each voice packet a sum of the LSP values extracted from that voice packet may be assigned a weight based on one or more other characteristics of that voice packet. For example, a weight may be assigned to the sum of LSP values extracted from the voice packet based on one or more of packet type (e.g., half rate, full rate, and the like), packet category (e.g., comparable and/or non-comparable, as well as other categories), degree of confidence (e.g., which may be proportional to one or more of the extracted voice coding parameters (such as volume, rate, and the like), one or more sequence-derived metrics, and the like, as well as various combinations thereof).

Although primarily depicted and described with respect to an embodiment in which the distance values are Euclidean distance values, in other embodiments other types of distance values may be used for determining whether there is similarity between the voice content of the target packets and the voice content of the reference packets. For example, other types of distance values, such as linear distance values, cubic distance values, and the like, may be used for determining whether there is similarity between the voice content of the target packets and the voice content of the reference packets.

Furthermore, although primarily depicted and described with respect to embodiments in which distance values are used for determining whether there is similarity between the voice content of the target packets and the voice content of the reference packets, the determination as to whether there is similarity between the voice content of the target packets and the voice content of the reference packets may be performed using other types of comparisons.

As depicted in FIG. 5, in one embodiment, optional post-processing may be performed. The post-processing may include any optimization heuristics. In one embodiment, the post-processing may be performed before a final determination is made that a similarity is identified. In one such embodiment, the post-processing is performed in a manner for determining whether the identified similarity is valid or invalid. In other words, the post-processing may be performed in a manner for attempting to eliminate false positives (i.e., in order to eliminate false identification of a similarity in the voice content of the target packets and the voice content of the reference packets).

As depicted in FIG. 5, in an embodiment in which post-processing is performed, if a similarity is identified at step 512, method 500 proceeds from step 512 to step 515A (rather than proceeding directly to step 516). At step 515A, post-processing, which may include one or more optimization heuristics, is performed to evaluate the validity of the identified similarity (i.e., to determine whether or not the similarity identified at step 512 was a false positive). At step 515B, a determination is made as to whether the identified similarity is valid. The determination as to whether the identified similarity is valid is made based on the post-processing.

If the identified similarity is not valid (i.e., a determination is made that the identified similarity was a false positive), a similarity is not identified for the current target packet (i.e., method 500 proceeds to step 514), and from step 514, method 500 returns to step 504 to re-execute method 500 for the next current target packet, i.e., i=i+1). If the identified similarity is valid (i.e., a determination is made that the identified similarity was not a false positive), a similarity is identified for the current target packet (i.e., method 500 proceeds to step 516), and from step 516, method 500 returns to step 504 to re-execute method 500 for the next current target packet, i.e., i=i+1).

The post-processing may be performed in any manner for evaluating whether or not an identified similarity is valid. In one embodiment, post-processing may be performed using LSP values extracted from the target packets and the reference packets. In one embodiment, post-processing may be performed using other voice coding parameters extracted from the target packets and/or the reference packets (e.g., rate information, encoding type information, volume/power information, gain information, and the like, as well as various combinations thereof). The other voice coding parameters may be extracted from the target packets and reference packets at any time (e.g., when the LSP values are extracted, after a similarity is identified using the extracted LSP values, and the like). In one embodiment, post-processing may be performed as depicted and described with respect to step 409 of method 400 of FIG. 4.

In one embodiment, when a similarity between voice content of the target packet stream and voice content of the reference packet stream is identified, validity of the identified similarity may be evaluated. The evaluation of the validity of an identified similarity may be performed in a number of different ways. As described herein, the evaluation of the validity of an identified similarity may be performed using evaluations of target voice packets and reference voice packets, rate pattern matching, rate/type matching, and the like, as well as various combinations thereof.

In one embodiment, the evaluation of the validity of an identified similarity may be performed using a comparison of volume characteristics of voice content of target packets and volume characteristics of voice content of reference packets. This evaluation of the validity of an identified similarity may be performed using a comparison of volume characteristics may be performed in conjunction with or in place of other methods of evaluating the validity of an identified similarity.

In one such embodiment, for example, volume information is extracted from each target packet and volume information is extracted from each reference packet, and the extracted volume information is evaluated. The extracted volume information may be evaluated in a pairwise manner (i.e., in a manner similar to the pairwise LSP comparisons depicted and described with respect to FIG. 5). The volume information may be extracted in any manner, and at any point in the process. For example, the volume information may be extracted as the LSP information is extracted, or may be extracted only after a similarity is identified (e.g., in order to prevent extraction of volume information where no volume comparison is required to be performed).

In one embodiment, K volume comparisons are performed, i.e., one for each combination of the N target packets and one of the K sets of N reference packets. In this embodiment, a volume comparison value is computed for each combination of the N target packets and one of the K sets of N reference packets, thereby producing a set (or vector) of K volume comparison values. In one embodiment, each of the K volume comparison values is compared against a volume threshold v_{TH}. If the volume comparison value satisfies v_{TH}, the associated LSP comparison for that combination of the N target packets and the associated one of the K sets of N reference packets is considered valid; and if the volume comparison value does not satisfy v_{TH}, the associated LSP comparison for that combination of the N target packets and the associated one of the K sets of N reference packets is considered invalid.

In one embodiment, the K volume comparison values are computed as ratios between volume values extracted from the N target packets and each of the K sets of volume values extracted from the K sets of N reference packets received during the window of i−Kₘᵢₙ . . . i−Kₘₐₓ−N. In one embodiment, the K volume comparison values form a volume comparison vector (denoted as Vᵢ^{T}). In this embodiment, volume comparison vector Vᵢ^{T}, which corresponds to the window of N target packets starting with target packet i, is defined as a vector of K volume comparison values (where K=Kₘₐₓ−Kₘᵢₙ+1) as follows: Vᵢ^{T}=[v_{i,i-K}_{ₘₐₓ}^{T}, v_{i,i-K}_{ₘₐₓ}₊₁^{T}, . . . , v_{i,i-K}_{ₘᵢₙ}^{T}]. In one embodiment, the volume comparison values v_{i,k}^{T} (with Kₘᵢₙ≦k≦Kₘₐₓ) are computed as follows:

$${v}_{i , k}^{T} = \frac{\frac{{v}_{k}^{R}}{{v}_{k}^{T}} + \frac{{v}_{k + 1}^{R}}{{v}_{k + 1}^{T }} + … + \frac{{v}_{k + N}^{R}}{{v}_{k + N}^{T}}}{N}$$

Although primarily depicted and described with respect to using rate pattern matching, rate/type matching, and/or volume comparison techniques for determining whether an identified similarity is considered to be valid, various other voice coding parameters extracted from target voice packets and/or reference voice packets may be used for determining whether an identified similarity is considered to be valid. For example, one or more of FCB gain information, ACB gain information, pitch information, and the like, as well as various combinations thereof, may be used for determining whether an identified similarity is considered to be valid.

As depicted in FIG. 5, if a similarity is identified for the current target packet (depicted as step 516), the echo-tail is automatically identified as a byproduct of the similarity determination. The echo path delay is computed as DELAY=k*f, where k is the value of k associated with the minimum distance value (i.e., min [e_{i,k}^{T}] identified at step 510 of method 500 of FIG. 5), and f is the sampling interval which may vary depending on the type of coding used (e.g., 20 ms for EVRC coding). Thus, using the present invention, the echo path delay is easily determined as a byproduct of the determination as to whether or not there is a similarity between voice content conveyed by target packets of the target packet stream and voice content conveyed by reference packets of the reference packet stream.

As described herein, hysteresis may or may not be employed in determining whether or not voice content of target packets includes echo of voice content of reference packets. In an embodiment in which hysteresis is not employed, identification of a similarity based on processing performed for a current target packet is deemed to be identification of an echo of the voice content of the reference packet stream in the voice content of the target packet stream. In an embodiment in which hysteresis is employed, identification of a similarity based on processing performed for a current target packet may or may not be deemed to be identification of an echo of the voice content of the reference packet stream in the voice content of the target packet stream (i.e., the determination will depend on one or more hysteresis conditions).

In one embodiment, application of hysteresis to echo detection of the present invention may require identification of a similarity for h consecutive target packets (i.e., for h consecutive executions of method 500 in which a similarity is identified) before a determination is made that an echo has been detected. In one embodiment, voice content of the target packets may be considered to include echo of voice content of the reference packets as long as similarity continues to be identified in consecutive target packets (e.g., for each consecutive target packet greater than h). In one embodiment, voice content of the target packets may be considered to include echo of voice content of the reference packets until h consecutive target packets are processed without identification of a similarity. In other word, where h=1, identification of a single similarity is deemed to be detection of echo (i.e., h=1 is a non-hysteresis embodiment).

In one embodiment, hysteresis determinations may be managed using a state associated with each target packet stream. In one such embodiment, each target packet stream may always be in one of two states: a NON-ECHO state (i.e., a state in which echo is not deemed to have been detected) and an ECHO state (i.e., a state in which echo is deemed to have been detected). If the target packet stream is in the NON-ECHO state, the target packet stream remains in the NON-ECHO state until a similarity is identified for h consecutive packets, at which point the target packet stream is switched to the ECHO state. If the target packet stream is in the ECHO state, the target packet stream remains in the ECHO STATE until h (or some other number of) consecutive target packets are processed without identification of a similarity, at which point the target packet stream is switched to the NON-ECHO state.

Thus, with respect to hysteresis requiring identification of similarity for h consecutive target packets before an echo is detected, where method 500 is performed as step 304 of method 300 of FIG. 3, step 304 of method 300 of FIG. 3 needs to be repeated until h consecutive executions of method 500 of FIG. 5 yield identification of a similarity. In other words, although omitted for purposes of clarity, step 306 of method 300 may implement hysteresis by preventing detection of echo until h consecutive executions of method 500 of FIG. 5 yield identification of a similarity. Furthermore, where hysteresis is employed in order to detect echo, additional post-processing may be performed, in response to an initial determination that echo is been detected, before echo suppression is applied to target packet(s). This additional post-processing (which may operate as an optional processing step disposed between steps 306 and 308 of FIG. 3) may be any type of post-processing, including but not limited to post-processing similar to the post-processing described with respect to step 409 of FIG. 4 and step 515 of FIG. 5.

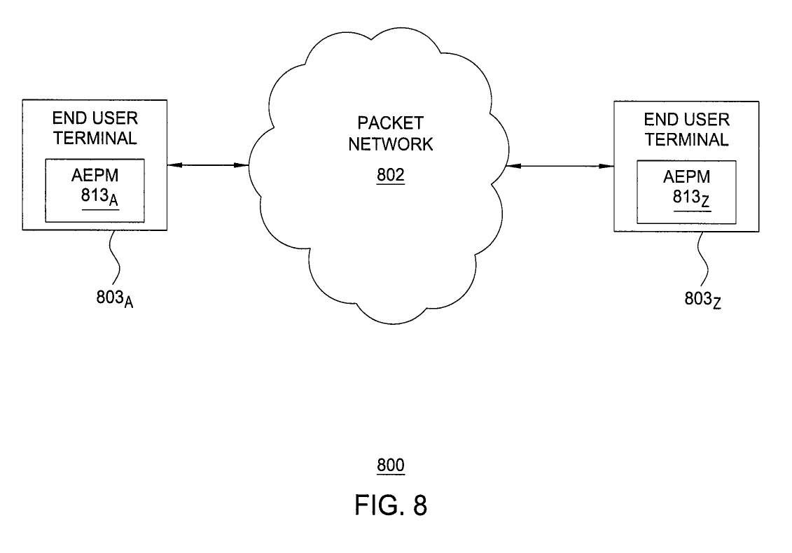

Although primarily depicted and described with respect to providing echo detection and suppression using an acoustic echo processing module deployed within the packet network (illustratively, using AEPM 120 deployed within packet network 102 of FIG. 1), the echo detection and suppression functions of the present invention may be implemented on the end user terminal (referred to herein as a terminal-based implementation). The use of terminal-based implementations of the present invention may be better understood with respect to FIG. 7 and FIG. 8.

FIG. 8 depicts a high-level block diagram of a communication network in which echo detection and suppression functions of the present invention are implemented within the end user terminals. Specifically, communication network 800 of FIG. 8 includes an end user terminal 803_{A} and an end user terminal 803_{Z} in communication over a packet network 802. Specifically, packet communication network 802 supports a packet-based voice call between end user terminal 803_{A} and end user terminal 803_{Z}. As depicted in FIG. 8, end user terminal 803_{A} includes an AEPM 813_{A} and end user terminal 803_{Z} includes an AEPM 813_{Z}. The AEPM 813_{A} provides echo detection and suppression functions of the present invention for end user A of terminal 103_{A}(and, optionally, may provide echo detection and suppression for end user Z of terminal 103_{Z}), and, similarly, AEPM 813_{Z} provides echo detection and suppression functions of the present invention for end user Z of terminal 103_{Z}(and, optionally, may provide echo detection and suppression for end user A of terminal 103_{A}).

Although depicted and described with respect to a voice call in which each end user terminal 803 of a packet-based voice call includes an AEPM 813, echo detection and suppression functions of the present invention may be provided where only one of the end users involved in the packet-based voice call is using an end user terminal 803 that includes an AEPM 813. In one such embodiment, where AEPM 813 of the end user terminal 803 supports unidirectional echo detection and suppression, only one of the end users will realize the benefit of the echo detection and suppression functions of the present invention (i.e., probably the local end user associated with the end user terminal 803 that includes the AEPM 813, although echo detection and suppression could instead be provided to the remote end user). In another such embodiment, where AEPM 813 of the end user terminal 803 supports bidirectional echo detection and suppression, both of the end users will realize the benefit of the echo detection and suppression functions of the present invention.

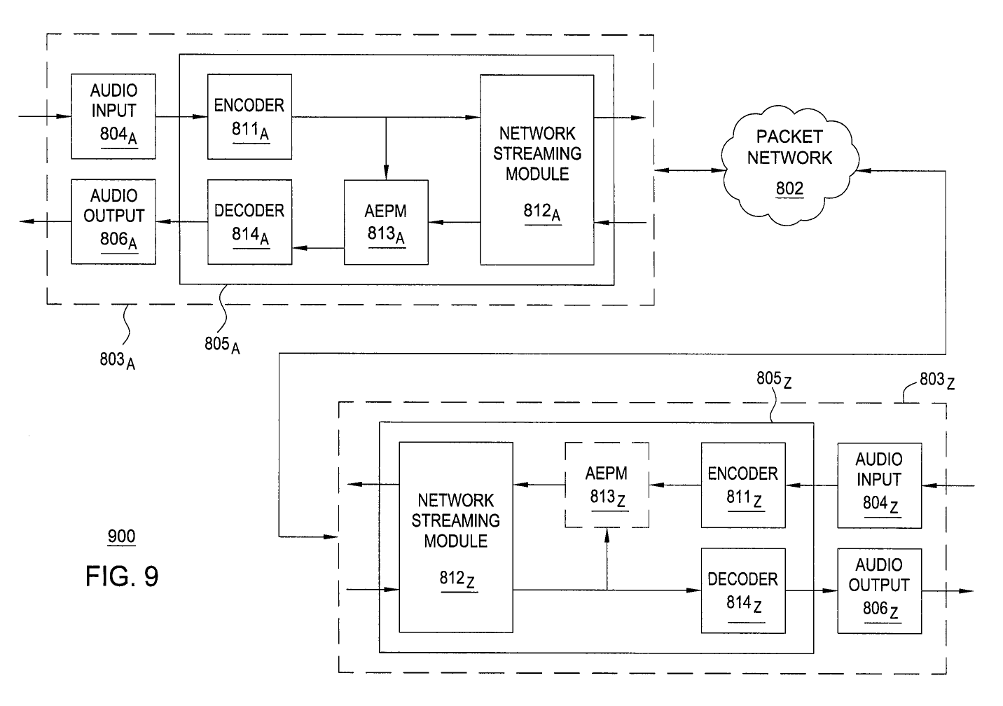

FIG. 9 depicts a high-level block diagram of a communication network in which echo detection and suppression functions of the present invention are implemented within the end user terminals. Specifically, communication network 900 of FIG. 9 includes an end user terminal 803_{A} and an end user terminal 803_{Z} in communication over a packet network 902, where each end user terminal 803 includes components for supporting voice communications. As depicted in FIG. 9, an end user terminal 803 includes components for supporting voice communications over packet networks, such as an audio input device (e.g., a microphone), an audio output device (e.g., speakers), and a network interface.

Specifically, end user terminal 803_{A} includes an audio input device 804_{A}, a network interface 805_{A}, and an audio output device 806_{A}, and end user terminal 803_{Z} includes an audio input device 804_{Z}, a network interface 805_{Z}, and an audio output device 806_{Z}. The audio input devices 804 and audio output device operate in a manner similar to audio input devices 104 and audio output devices 106 of end user terminals 103 of FIG. 1. The components of the end user terminals 803 may be individual physical devices or may be combined in one or more physical devices. For example, end user terminals 803 may include computers, VoIP phones, and the like.

The network interfaces 805 operate in a manner similar to network interfaces 105 of FIG. 1 with respect to encoding/decoding capabilities, packetization capabilities, and the like; however, unlike end user terminals 103 of FIG. 1, end user terminal 803_{A} (and, optionally, end user terminal 803_{Z}) of FIG. 9 is adapted to include an AEPM supporting echo detection and suppression/cancellation functions of the present invention. The network interface 805_{A} includes an encoder 811_{A}, a network streaming module 812_{A}, an AEPM 813_{A}, and a decoder 814_{A}. The network interface 805_{Z} includes an encoder 811_{Z}, a network streaming module 812_{Z}, an AEPM 813_{Z}, and a decoder 814_{Z}.

The end user terminal 803_{A} provides speech to end user terminal 803_{Z}. The speech of end user A is picked up by audio input device 804_{A} (for purposes of clarity, assume that there is no echo coupling at end user terminal 803_{A}). The audio input device 804_{A} provides the speech to encoder 811_{A}, which encodes the speech. The encoder 811_{A} provides the encoded speech to network streaming module 812_{A} for streaming the encoded speech toward end user terminal 803_{Z} over packet network 802. The encoder also provides the encoded speech to AEPM 813_{A} for use as the reference packet stream for detecting and suppressing/canceling echo of the speech of end user A in the target packet stream (which is received from end user terminal 803_{Z}). The end user terminal 803_{Z} receives streaming encoded speech from end user terminal 803_{A}. The network streaming module 812_{Z} receives streaming encoded speech from end user terminal 803_{A}. The network streaming module 812_{Z} provides the encoded speech to decoder 814_{A}. The decoder 814_{Z} decodes the encoded speech and provides the decoded speech of end user A to audio output device 806_{Z}, which plays the speech of end user A.

The end user terminal 803_{Z} provides speech to end user terminal 803_{A}. The speech of end user Z is picked up by audio input device 804_{Z}. The speech of end user A (i.e., speech played by audio output device 806_{Z}) may also be picked up by audio input device 804_{Z} (i.e., as echo). The audio input device 804_{Z} provides the speech to encoder 811_{Z}, which encodes the speech. The encoder 811_{Z} provides the encoded speech to network streaming module 812_{Z} for streaming the encoded speech toward end user terminal 803_{A} over packet network 802. The end user terminal 803_{A} receives streaming encoded speech from end user terminal 803_{Z}. The network streaming module 812_{A} receives streaming encoded speech from end user terminal 803_{Z}. The network streaming module 812_{A} provides the encoded speech to AEPM 813_{A} for use as the target packet stream for detecting and suppressing echo of the speech of end user A in the target packet stream. The AEPM 713_{A} detects and suppresses/cancels any echo, and provides the adapted target packet stream to decoder 814_{A}. The decoder 814_{A} decodes the encoded speech and provides the decoded speech of end user Z to audio output device 806_{A}, which plays the speech of end user Z.

As depicted in FIG. 9, since end user terminal 803_{A} has access to the original stream of voice packets transmitted from end user terminal 803_{A} to end user terminal 803_{Z} (denoted as the reference packet stream), and has access to the return stream of voice packets transmitted from end user terminal 803_{Z} to end user terminal 803_{A} (denoted as the target packet stream), end user terminal 803_{A} is able to apply the echo detection and suppression functions of the present invention for detecting and suppressing echo of end user A associated with end user terminal 703_{A}. As depicted in FIG. 9, however, an end user terminal may access reference packet streams and target packet streams in various other ways for purposes of performing the echo detection and suppression/cancellation processing of the present invention.

As depicted and described with respect to FIG. 9, in one embodiment in which echo detection and suppression/cancellation is implemented on an end user terminal, echo detection and suppression/cancellation functions of the present invention may be applied to a target packet stream on the receiving end user terminal. For example, AEPM 813_{A} of end user terminal 803_{A} may apply echo processing to prevent echo from being included in audio played out from end user terminal 803_{A} (i.e., echo processing is applied after the target packet stream has already traversed packet network 802 from end user terminal 803_{Z}). Similarly, for example, AEPM 813_{Z} of end user terminal 803_{Z} may apply echo processing to prevent echo from being included in audio played out from end user terminal 803_{Z} (i.e., echo processing is applied after the target packet stream has already traversed packet network 802 from end user terminal 803_{A}).

As depicted and described with respect to FIG. 9, in one embodiment in which echo detection and suppression/cancellation is implemented on an end user terminal, echo detection and suppression/cancellation functions of the present invention may be implemented on a target packet stream on the transmitting end user terminal. For example, AEPM 813_{Z} of end user terminal 803_{Z} may apply echo processing to prevent echo from being included in audio played out from end user terminal 803_{A} (i.e., echo processing is applied before the target packet stream has traversed packet network 802 from end user terminal 803_{Z} to end user terminal 803_{A}). Similarly, for example, AEPM 713_{A} of end user terminal 803_{A} may apply echo processing to prevent echo from being included in audio played out from end user terminal 803_{Z} (i.e., echo processing is applied before the target packet stream has traversed packet network 802 from end user terminal 803_{A} to end user terminal 803_{Z}).

Furthermore, although primarily depicted and described as alternative embodiments, in one embodiment an end user terminal may support echo detection and suppression in both directions of transmission. In one such embodiment, a single AEPM may be implemented: (1) between the encoder and the network streaming module for providing echo detection and suppression in the transmit direction before the target packet stream traverses the network and (2) between the network streaming module and the decoder for providing echo detection and suppression in the receive direction after the target packet stream traverses the network. In another embodiment, an end user terminal may be implemented using separate AEPMs for the transmit direction and receive direction.

Thus, it may be noted that where two end user terminals participate in a packet-based voice call over a packet network, but only one of the two end user terminals includes the echo detection and suppression functions of the present invention, that one end user terminal can nonetheless provide echo detection and suppression in both directions of transmission such that the end user using the end user terminal that does not support packet-based echo detection and suppression still enjoys the benefit of the packet-based echo detection and suppression.

Although primarily depicted and described with respect to providing echo detection and suppression in one direction of transmission of a bidirectional voice call, echo detection and suppression in accordance with the present invention may be provided in both directions of transmission of a bidirectional voice call. In one embodiment, echo detection and suppression may be provided in both directions of transmission using a network-based implementation (i.e., where both directions of transmission traverse a network-based AECM). In one embodiment, echo detection and suppression may be provided in both directions of transmission using a terminal-based implementation (i.e., where both end user terminals include AECMs). In one embodiment, echo detection and suppression may be provided in both directions of transmission using a combination of network-based and terminal-based implementations. For example, where only one end-user terminal includes an AECM, echo cancellation and suppression may be provided by the end user terminal in one direction of transmission and by the network in the other direction of transmission (or by the network in both directions).

Although primarily depicted and described with respect to a packet-based voice call between two end users, the echo detection and suppression functions of the present invention may be used for echo detection and suppression between packet-based voice calls between more than two end users. In such embodiments, network-based echo detection and suppression and/or terminal-based echo detection and suppression may be utilized in order to detect and suppress echo between different combinations of the end users participating in the packet-based voice call.

Although primarily depicted and described with respect to one voice call, the present invention may be performed for each voice call supported by the network. For a network-based implementation, depending on the design of the AEPM, one AEPM may be able to support the volume of calls that the network is capable of supporting or, alternatively, multiple AEPMs may be deployed within the network such that the echo detection and suppression functions of the present invention may be supported for all voice calls that the network is capable of supporting. For a terminal-based implementation, the scaling of support for the echo detection and suppression functions of the present invention will take place as end users replace existing user terminals with enhanced user terminals including AEPMs providing the echo detection and suppression functions of the present invention.

In one embodiment, a combination of network-based implementation and terminal-based implementation of echo detection and suppression functions of the present invention is employed. This combined implementation may be employed for various different reasons, e.g., in order to provide echo detection and suppression during a transition period in which end users are switching from existing end user terminals (that do not include AEPMs of the present invention) to end user terminals including AEPMs providing the echo detection and suppression functions of the present invention. A balance between network-based implementation and terminal-based implementation may be managed in a number of different ways.

In one such embodiment, for example, estimates of terminal-based implementations may be used to scale the network-based implementation (e.g., where a network-based implementation is used to provide echo detection and suppression for end users that do not have end user terminals that support the echo detection and suppression capabilities of the present invention). In other words, as end users begin switching from existing end user terminals (that do not include AEPMs of the present invention) to end user terminals including AEPMs providing the echo detection and suppression functions of the present invention, the scope of the network-based implementation may be scaled back accordingly.

Although primarily depicted and described herein with respect to providing echo detection and suppression for voice content in point-to-point calls, the echo detection and suppression functions of the present invention may be used to provide echo detection and suppression for voice content in multi-party calling (e.g., voice conferencing). Although primarily depicted and described with respect to providing echo detection and suppression for voice content, the echo detection and suppression functions of the present invention may be used to provide echo detection and suppression for other types of audio content. Similarly, although primarily depicted and described herein with respect to providing echo detection and suppression for audio content in general, the echo detection and suppression functions of the present invention may be used to provide echo detection and suppression for other types of content which may include echo. Furthermore, although primarily depicted and described with respect to detection and suppression of acoustic echo, the present invention may be used for detecting and suppression other types of echo which may be introduced in audio-based communication systems (e.g., line echo, hybrid echo, and the like, as well as various combinations thereof). In other words, the present invention is not intended to be limited by the type of echo or the type of content in which the echo may be introduced.

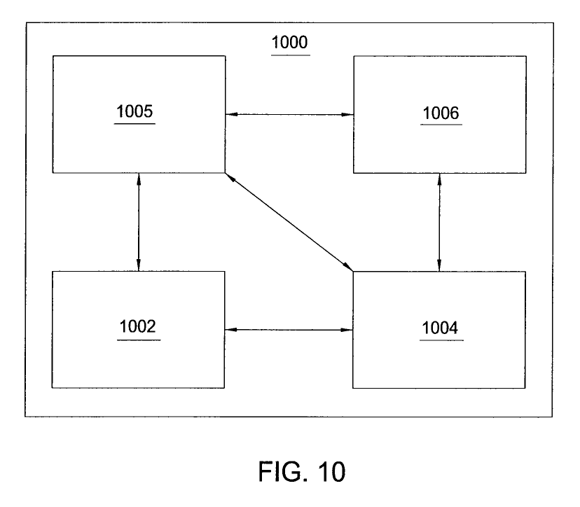

FIG. 10 depicts a high-level block diagram of a general-purpose computer suitable for use in performing the functions described herein. As depicted in FIG. 10, system 1000 comprises a processor element 1002 (e.g., a CPU), a memory 1004, e.g., random access memory (RAM) and/or read only memory (ROM), an acoustic echo processing module (AEPM) 1005, and various input/output devices 1006 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present AEC process 1005 can be loaded into memory 1004 and executed by processor 1002 to implement the functions as discussed above. As such, AEC process 1005 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for detecting echo in a packet-based communication network, comprising:
extracting voice coding parameters from target packets of a target packet stream;
extracting voice coding parameters from reference packets of a reference packet stream;
determining whether voice content of the target packet stream is similar to voice content of the reference packet stream by processing the voice coding parameters of the target packets and the voice coding parameters of the reference packets; and
determining whether the target packet stream includes an echo of the reference packet stream based on the determination as to whether the voice content of the target packet stream is similar to voice content of the reference packet stream.

2. The method of claim 1, further comprising:
in response to a determination that the target packet stream includes an echo of the reference packet stream, suppressing the echo of target packet stream.

3. The method of claim 2, wherein suppressing the echo of the target packet stream comprises:
attenuating the voice content of the target packet stream.

4. The method of claim 2, wherein suppressing the echo of the target packet stream comprises:
replacing at least one of the packets of the target packet stream with at least one of a silence packet, a packet having white noise, and a packet having comfort noise.

5. The method of claim 1, wherein the voice coding parameters comprise at least one of frequency parameters, volume parameters, and packet type parameters.

6. The method of claim 1, wherein determining whether voice content of the target packet stream is similar to voice content of the reference packet stream, comprises:
(a) extracting a set of LSPs from a set of consecutive ones of the target packets of the target packet stream associated with a sliding window;
(b) extracting K sets of LSPs from K sets of consecutive ones of the reference packets of the reference packet stream;
(c) comparing the set of LSPs from the target packet stream with each of the K sets of LSPs from the reference packet stream; and
(d) determining whether voice content of the target packet stream is similar to voice content of the reference packet stream using the comparison of the set of LSPs from the target packet stream with each of the K sets of LSPs from the reference packet stream.

7. The method of claim 6, wherein step (c) comparing the set of LSPs from the target packet stream with each of the K sets of LSPs from the reference packet stream comprises:
(c1) selecting one of the K sets of LSPs from the reference packet stream;
(c2) calculating a distance value for the set of LSPs from the target packet and the selected one of the K sets of LSPs from the reference packet stream;
(c3) repeating steps (c1)-(c2) for each of the K sets of LSPs from the reference packet stream;
(c4) comparing at least one of the distance values to an LSP similarity threshold;
(c5) in response to a determination that at least one of the distance values satisfies the LSP similarity threshold, identifying a similarity between voice content of the target packet stream and voice content of the reference packet stream.

8. The method of claim 7, wherein the distance value for the set of LSPs from the target packet and the selected one of the K sets of LSPs from the reference packet stream is calculated as:
$${e}_{i , k}^{T} = \sqrt{{\sum }_{I = i}^{i + N} {\sum }_{α = 1}^{M} {( {l}_{I , α}^{T} - {l}_{I - k , α}^{R} )}^{2}}$$

9. The method of claim 7, wherein the distance values comprise Euclidean distance values.

10. The method of claim 7, wherein step (c4) of comparing at least one of the distance values to an LSP similarity threshold comprises:
identifying the minimum distance value; and
comparing the minimum distance value to the LSP similarity threshold.

11. The method of claim 7, wherein the at least one of the distance values satisfies the LSP similarity threshold if the at least one of the distance values is less than the LSP similarity threshold.

12. The method of claim 7, further comprising:
in response to identifying a similarity at step (c5), evaluating validity of the identified similarity.

13. The method of claim 12, wherein evaluating the validity of the identified similarity is performed using at least one of rate/pattern matching, rate/type matching, and a volume comparison.

14. The method of claim 13, wherein rate/pattern matching comprises:
categorizing each of the target packets and the reference packets as comparable or non-comparable;
determining a number of target packets and reference packets deemed to be matching;
determining a number of target packets categorized as comparable;
determining a rate/pattern matching value using the number of target packets and reference packets deemed to be matching and the number of target packets categorized as comparable; and
comparing the rate/pattern matching value to a rate/pattern matching threshold.

15. The method of claim 13, wherein rate/type matching comprises:
categorizing each of the target packets and the reference packets using a rate of the packet and a type of the packet;
comparing the packet categories of target packets to the packet categories of reference packets, respectively;
determining a weight associated with each comparison of packet category of target packet to packet category of reference packet;
computing rate/type matching value by summing the weights of the respective comparisons; and
comparing the rate/type matching value to a rate/type matching threshold.

16. The method of claim 13, wherein the volume comparison technique comprises:
extracting volume values from consecutive ones of the target packets of the target packet stream;
extracting volume values from consecutive ones of the reference packets of the reference packet stream;
computing volume comparison values using the volume values from the target packets and the volume values from the reference packets; and
comparing each of the volume comparison values to a volume threshold.

17. The method of claim 1, wherein the determination as to whether voice content of the target packet stream is similar to voice content of the reference packet stream is performed using at least one of rate/pattern matching, rate/type matching, and a volume comparison.

18. The method of claim 17, wherein rate/pattern matching comprises:
extracting a set of voice coding parameters from a set of consecutive ones of the target packets of the target packet stream associated with a sliding window;
extracting K sets of voice coding parameters from K sets of consecutive ones of the reference packets of the reference packet stream;
categorizing each of the target packets and the reference packets as comparable or non-comparable, wherein the target packets and reference packets are categorized using packet rate information extracted from the respective packets;
comparing the set of voice coding parameters from the target packet stream with each of the K sets of voice coding parameters from the reference packet stream while ignoring voice coding parameters extracted from packets categorized as non-comparable; and
determining whether voice content of the target packet stream is similar to voice content of the reference packet stream using the comparisons of the set of voice coding parameters from the target packet stream with each of the K sets of voice coding parameters from the reference packet stream.

19. The method of claim 17, wherein rate/type matching comprises:
categorizing each of the target packets of a set of consecutive ones of the target packets of the target packet stream using a rate of the packet and a type of the packet;
categorizing each of the target packets of K sets of consecutive ones of the reference packets of the reference packet stream using a rate of the packet and a type of the packet; and
performing, for each of the K sets of reference packets:
comparing the packet categories of the target packets to the packet categories of the reference packets of that set of reference packets;
determining a weight associated with each comparison of packet category of target packet to packet category of reference packet;
computing rate/type matching value by summing the weights of the respective comparisons; and
comparing the rate/type matching value to a rate/type matching threshold.

20. The method of claim 17, wherein the volume comparison technique comprises:
extracting a set of volume values from a set of consecutive ones of the target packets of the target packet stream;
extracting K sets of volume values from K sets of consecutive ones of the reference packets of the reference packet stream;
computing K volume comparison values using the set of volume values from the target packets and the sets of volume values from the K sets of reference packets; and
comparing each of the K volume comparison values to a volume threshold.

21. The method of claim 6, further comprising:
(e) shifting the sliding window of the target packet stream by one packet;
(f) repeating steps (a)-(d).

22. The method of claim 21, further comprising:
in response to h consecutive similarities, concluding that the target packet stream includes an echo of the reference packet stream.

23. An apparatus for detecting echo in a packet-based communication network, comprising:
means for extracting voice coding parameters from target packets of a target packet stream;
means for extracting voice coding parameters from reference packets of a reference packet stream;
means for determining whether voice content of the target packet stream is similar to voice content of the reference packet stream by processing the voice coding parameters of the target packets and the voice coding parameters of the reference packets; and
means for determining whether the target packet stream includes an echo of the reference packet stream based on the determination as to whether the voice content of the target packet stream is similar to voice content of the reference packet stream.

24. A computer-readable medium storing instructions which, when executing by a computer, cause the computer to perform a method for detecting echo in a packet-based communication network, the method comprising:
extracting voice coding parameters from target packets of a target packet stream;
extracting voice coding parameters from reference packets of a reference packet stream;
determining whether voice content of the target packet stream is similar to voice content of the reference packet stream by processing the voice coding parameters of the target packets and the voice coding parameters of the reference packets; and
determining whether the target packet stream includes an echo of the reference packet stream based on the determination as to whether the voice content of the target packet stream is similar to voice content of the reference packet stream.
